(19) United States
(12) Patent Application Publication
(10) Pub. No.: US 2018/0257144 A1
(43) Pub. Date: Sep. 13, 2018

(54) Low temperature method to produce coinage metal nanoparticles

(71) Applicant: National Technology & Engineering Solutions of Sandia, LLC, Albuquerque, NM (US)

(72) Inventors: Timothy J. Boyle, Albuquerque, NM (US); LaRico Juan Treadwell, Albuquerque, NM (US); Nelson S. Bell, Albuquerque, NM (US)

(21) Appl. No.: 15/911,854

(22) Filed: Mar. 5, 2018

Related U.S. Application Data
(60) Provisional application No. 62/469,194, filed on Mar. 9, 2017.

(51) Int. Cl. B22F 9/24; C09D 11/037; C09D 11/322

(52) U.S. Cl. CPC B22F 9/24; C09D 11/037; B22F 2304/05; B22F 2301/10; B22F 2301/255; C09D 11/322

(57) ABSTRACT

A method to produce coinage metal nanoparticles reduces the time and temperature of processing of previous methods. The method enables the production of significantly larger batches of high quality metal nanoparticles. A xylene-based solvent can be used to form low viscosity nanoinks from the metal nanoparticles. Aerosol deposition and inkjet printing of the low viscosity nanoinks can support feature realization in the sub-50 μm range, useful for electronic device fabrication.

### CROSS-REFERENCE TO RELATED APPLICATION

This application claims the benefit of U.S. Provisional Application No. 62/469,194, filed Mar. 9, 2017, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to methods to produce metal nanoparticles and, in particular, to a low temperature method to produce coinage metal nanoparticles that can be used to produce printable nanoinks.

### BACKGROUND OF THE INVENTION

Currently, nanoinks used in Direct Write Advanced Manufacturing (DW-AM) have been adopted from other manufacturing and printing processes. See S. D. Bunge, et al., Nano Letters 3, 901 (2003). The physical properties of these nanoinks suffer from non-ideal rheological properties, long-term stability, post-processing envelopes, limited availability, particle size variation, inclusion of contaminants, and limited variety. Historically, these nanoinks are Ag⁰ or Au⁰ based since these metal nanoinks can be processed under atmospheric conditions at relatively low temperatures. However, these metals are incompatible with some semiconductor processes. See S. D. Bunge, et al., Nano Letters 3, 901 (2003).

As a result, there is a need to develop semiconductor friendly coinage metal nanoinks and rapid processing routes for annealing printed elements necessary to the successful integration of DW-AM with the existing lithography infrastructure. Further, these nanoinks must be reproducibly manufactured at large scale.

### SUMMARY OF THE INVENTION

The present invention is directed to a method to produce coinage metal nanoparticles comprising reacting a coinage metal mesityl with a solvent/reductant at a sufficiently high temperature to produce coinage metal nanoparticles. The method can be used to produce high quality coinage metal (i.e., copper, silver, and gold) nanoparticles and printable nanoinks therefrom. As an example, a simple, low temperature route (˜130° C.) can generate high quality copper nanoparticles (Cu NPs). For example, the method can be scaled up to generate high quality Cu NPs that could be used for the production of Cu nanoinks. A xylene-based solvent can be used to form low viscosity nanoinks. A hyperdispersant, such as an amine surfactant, can be used to disperse the nanoparticles in the nanoink solvent. Cu NP dispersions with near Newtonian viscosity of 10 mPas were generated. Aerosol deposition and inkjet printing of low viscosity inks were found to support feature realization in the sub 50 μm range.

### BRIEF DESCRIPTION OF THE DRAWINGS

The detailed description will refer to the following drawings, wherein like elements are referred to by like numbers.

FIG. 1 is a graph of powder X-ray diffraction (PXRD) patterns of Cu NPs producing using a solvent mixture (mix) of 8N and HDA, 8N only, and HDA only. * indicates background for the plastic dome holder. • indicates residual HDA.

FIGS. 2(a)-(c) are transmission electron microscope (TEM) images of Cu NPs synthesized from (a) mix, (b) 8N, and (c) HDA.

FIG. 3 is a graph of dynamic light scattering (DLS) measurements of particle size distributions for Cu NPs synthesized from mix, 8N, and HDA solvents and dispersed in xylene with a hyperdispersant.

FIGS. 4(a)-(h) are TEM images of aliquots of Cu NPs prepared at (a) 115, (b) 125, (c) 135, (d) 145, (e) 155, (f) 165, (g) 175, and (h) 185° C.

FIG. 5 is a graph of DLS measurements of mix Cu NPs in xylene at 175° C. and 185° C., and Cu NPs dispersed in a xylene-white spirits solvent.

FIG. 6 is a graph of small angle X-ray scattering (SAXS) plots of mix Cu NP aliquots (50 g prep, Schlenk line) prepared at 115, 125, 135, 145, 155, 165, 175, and 185° C.

FIG. 7 is a graph of PXRD of aliquots from HDA-only Cu NPs (50 g prep, glovebox): (a) 110° C. (R=6.73%, 7 nm), (b) 120° C. (R=5.74%, 16 nm), (c) 130° C. (R=9.35%, 2 nm), (d) 140° C. (R=6.27%, 2 nm), (e) 150° C. (R=5.16%, 2 nm), (f) 160° C. (R=3.595%, 5 nm), (g) 170° C. (R=5.17%, 1 nm), and (h) 180° C. (R=5.75%, 4 nm).

FIG. 8 are TEM images of aliquots from HDA-only Cu NPs prepared at 110, 120, 130, 140, 150, 160, 170, and 180° C.

FIG. 9 is a plot of mix Cu NP rheological profiles in xylene vs. volume fraction.

### DETAILED DESCRIPTION OF THE INVENTION

A synthetic method has been described that generates coinage metal (Group 11) nanoparticles through the use of metal mesityl (M(Mes), M=Cu, Ag Au) precursors dissolved in octylamine (8N) and injection of this mixture into hexadecylamine (HDA) at elevated temperatures (e.g., 310° C.). See U.S. Pub. No. 2017/0181291, which is incorporated herein by reference. A typical reaction mixture using this method led to a small scale (˜1-2 g) batch of fairly regular nanoparticles; however, size variants were often encountered due to inconsistent sample preparation, processing time, and varied heating. Further, at this high temperature the energetic and complex experimental synthesis prohibits larger sized reactions to be easily undertaken. Accordingly, the present invention is directed to a method to generate large scales (˜100 g) of coinage metal NPs for nanoinks that reduces the time and temperature of processing.

The method of the present invention comprises reacting a coinage metal mesityl with a solvent/reductant at a sufficiently high temperature to produce coinage metal nanoparticles. The method involves using variations of the exemplary copper preparatory route:

CuCl+(Mes)MgBr→Cu(Mes)+MgBrCl (1)

Cu(Mes)→Cu⁰+. . . (2)

As an example of the invention, the precursor copper mesityl Cu(Mes) was first prepared by transferring in a glove box, copper(I) chloride (CuCl, 50.0 g, 274 mmmol) into a Schlenk flask containing tetrahydrofuran (THF, 1 L), dioxane (diox, 250 mL), and a stir bar. Mesityl magnesium bromide ((Mes)MgBr, 505 mL) was added to a different Schlenk flask. The two Schlenk flasks were removed from the glove box, attached to a Schlenk line, and cooled to 0° C. for ½ h. The (Mes)MgBr was slowly, cannula transferred into the stirring solution of CuCl/THF/diox. The reaction was allowed to warm to room temperature over a 12 h period and filtered. The mother liquor was dried, washed with hexanes (˜300 mL), and then extracted with toluene (˜400 mL). Single crystals of [Cu(μ-Mes)]₅ were grown by slow evaporation of the toluene.

To prepare copper nanoparticles (Cu NPs) using a mixture (mix) of solvents, Cu(Mes) (2.0 g, 11 mmol), and octylamine (8N, 10 g, 77 mmol) were added to a round bottomed flask containing hexadecylamine (HDA, 7.0 g, 29 mmol) in an argon glovebox. The reaction was heated to 180° C., held for 5 min and then allowed to cool to room temperature. The solidified solution was transferred back into an argon filled glovebox, where the Cu NPs were extracted with toluene (tol, ˜10 mL) and precipitated with methanol (MeOH, ˜100 mL). The yield was 115% (0.80 g).

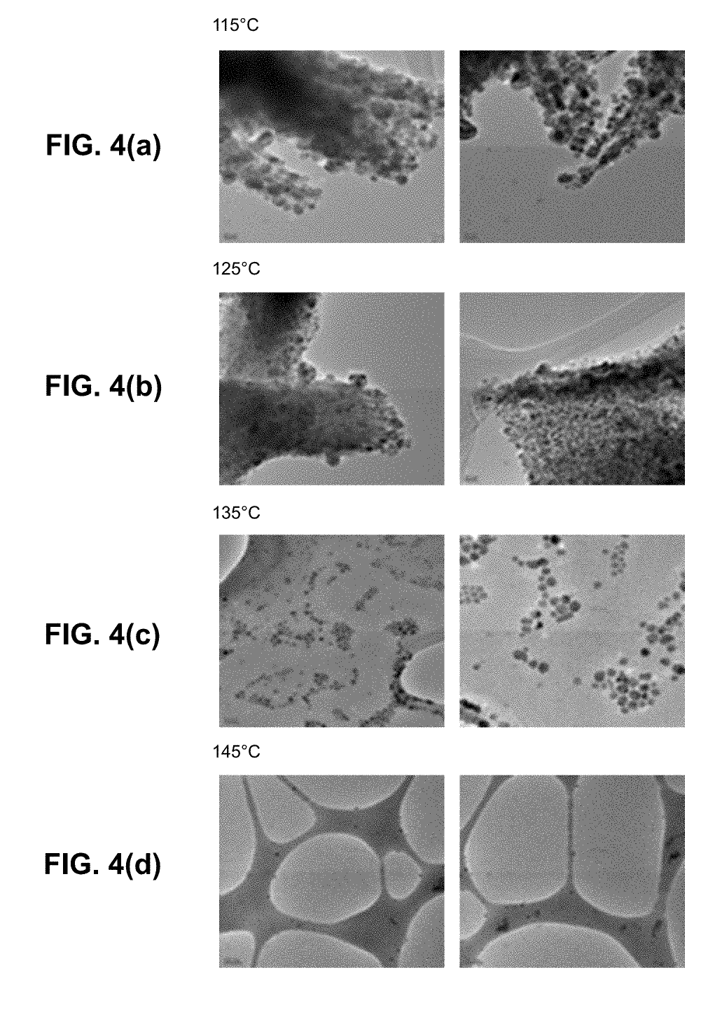

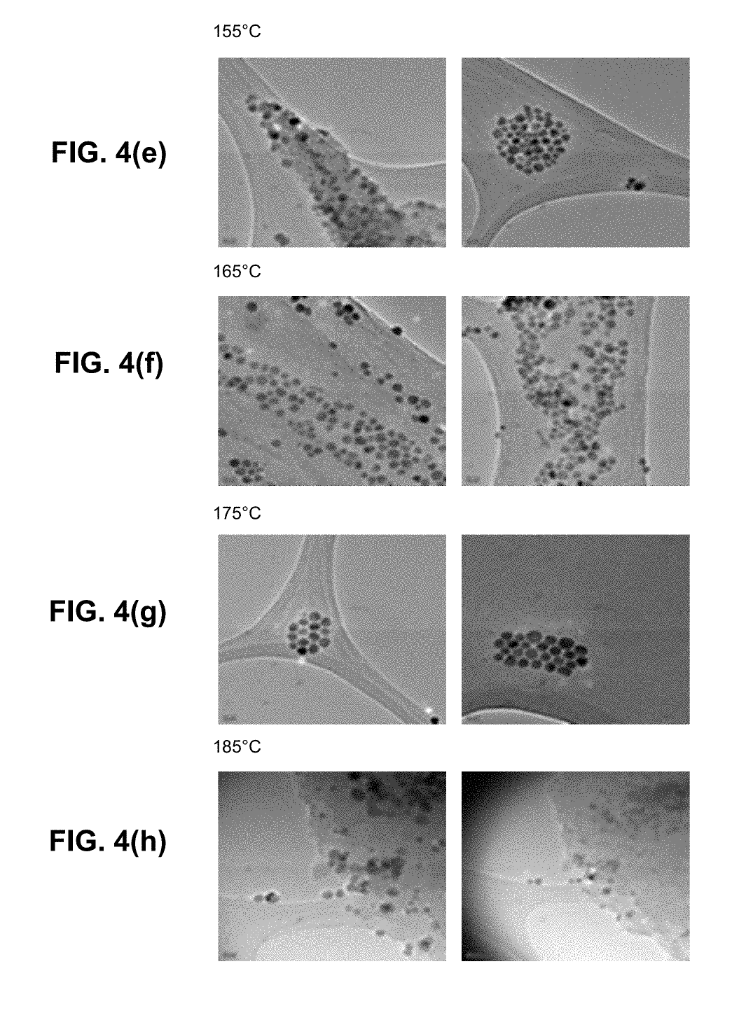

The lowest temperature that would induce the reduction of the copper mesityl precursor to form copper nanoparticles was first determined. To prepare Cu NPs, a mixture of Cu(Mes), HDA, and 8N were mixed in a round-bottomed flask in a glove box, heated, and monitored by a thermocouple, as described above. A red solution (indicative of Cu^{o} NP) developed at reaction temperatures as low as 130° C., which continued to darken as the temperature increased. The sample was held for 5 min at 180° C. and then washed as noted for the original synthesis. At pre-selected temperatures, an aliquot of the stirring reaction mixture was collected and placed in argon-filled vials. The aliquots were transferred to a glovebox, individually washed (with toluene and MeOH) and then dissolved in toluene to produce transmission electron microscopy (TEM) samples. TEM images of the resulting washed product, shown in FIGS. 4(a)-(h), indicate that high quality Cu NPs with organic ligands attached had been synthesized.

Reactions with Cu(Mes) using 8N-only and HDA-only were also performed. In general, the synthesis comprised simply mixing the appropriate solvent system with Cu(Mes) powder, stirring, and heating to 180° C. for 5 min. After this time, the reaction was allowed to cool to room temperature, and worked up as described above (toluene and MeOH washes). FTIR spectra were obtained for the 8N- and HDA-only samples and these spectra (as well as the mix sample) look nearly identical but different from the anticipated spectra of CuO or Cu(OH)₂. This implies the observed spectra are due to the ligand/solvent employed. Additional analytical data (PXRD patterns, TEM images, DLS measurements, UV-vis, and SAXS analyses) were collected on these samples and are described below.

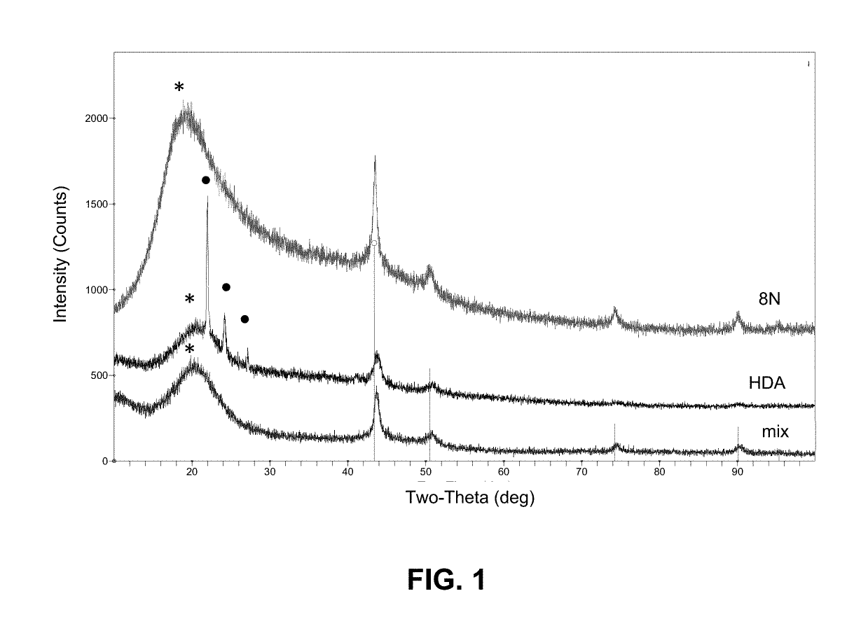

FIG. 1 shows the PeD PXRD pattern for Cu NPs synthesized at 180° C. for the three solvent systems (mix, 8N, HDA). As can be readily discerned, independent of the solution used in the synthesis, crystalline Cu^{o} was produced. From the patterns, the sizes of the particles were calculated as: mix=12 nm; 8N=7 nm; HDA=6 nm. For each sample, there is significant residual HDA and/or 8N present after washing. This, coupled with the FTIR data, is indicative of surface-bound surfactants.

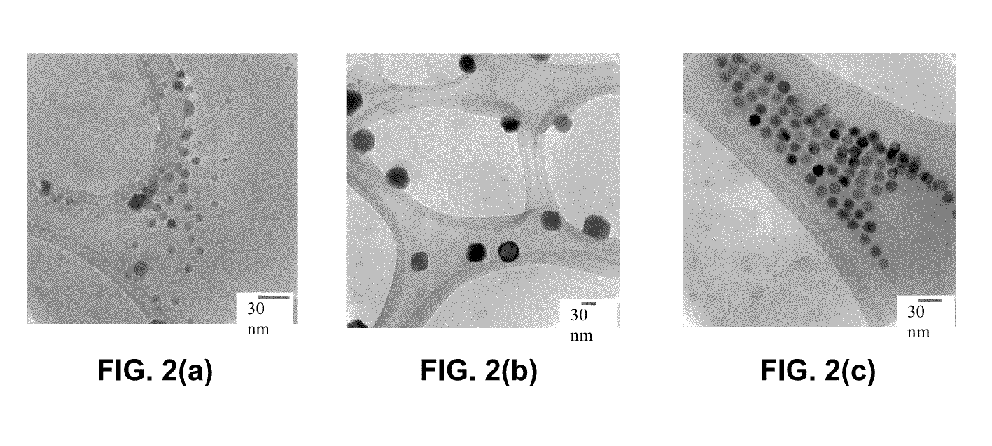

FIGS. 2(a)-(c) show TEM images of the various samples. As shown in FIG. 2(a), for the Cu NPs synthesized from the solvent mixture, a mixture of particle sizes was noted but all were 10 nm or smaller with the majority appearing around 10 nm, consistent with the PXRD pattern analysis. As shown in FIG. 2(b), the 8N-only samples appeared to be much larger, approaching 40-50 nm in size. However, the PXRD pattern indicates much smaller particles for the 8N-only synthesis. This variance is due to the measurement of crystallite size by the Scheerer analysis versus the particle size observed in the TEM. Finally, as shown in FIG. 2(c), the HDA-only images showed very uniform 8 nm sized particles which are similar to the expected size based on the PXRD analyses.

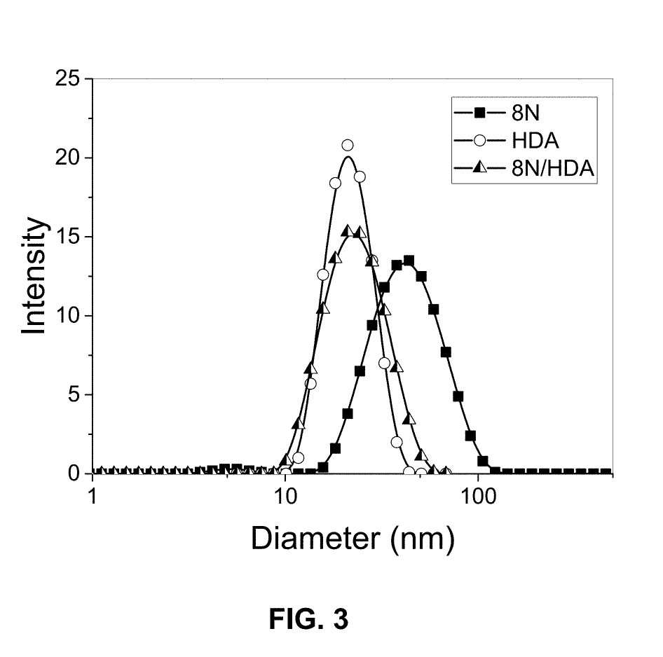

In FIG. 3 is shown a dynamic light scattering (DLS) analysis of the three different solvent samples. The TEM observation of the mix and HDA Cu NPs being smaller than the 8N Cu NPs is verified by these DLS data. The slight variation from the PXRD pattern analyses and TEM images in terms of absolute size for the 8N Cu NPs may be a reflection of clustering in solution.

A critical aspect of nanoinks is the ability to maintain stability over an extended period of time. Therefore, the samples were analyzed by PeD PXRD and then opened to the atmosphere to evaluate the rate of oxidation. Patterns obtained from unexposed and Cu NPs exposed to air for 13 minutes clearly indicate metallic Cu^{o}. A pattern obtained from Cu NPs exposed to air overnight (12 hr) indicate the formation of CuO, but with Cu^{o} still present in a significant amount. This implies that the 8N and HDA ligands inhibit immediate oxidation of the Cu NPs, which portends well for Cu^{o} printing applications.

To be useful for nanoinks, the nanoparticles must be capable of being produced on a larger scale. Therefore, large scale routes were pursued for the mix and the HDA-only samples. In particular, a Schlenk line preparation of the mix nanoparticles was pursued, followed by a glovebox preparation using HDA only system.

To prepare larger amounts of nanoparticles with a mixture (mix) of solvents, HDA (350 g, 1.45 mol), 8N (˜60 mL), and Cu(Mes) (50 g, 274 mmol) were loaded in a round bottomed flask with a stir bar in an argon glovebox. The reaction was transferred to a Schlenk line, heated from room temperature to 180° C., held for 5 min and then allowed to cool to room temperature. At selected intervals, aliquots (˜3 mL) were removed and transferred back into a glovebox. After the heating mantle was removed and the reaction allowed to cool to room temperature, the solidified solution was placed under vacuum and transferred back into an argon filled glovebox. For all samples, the Cu NPs were extracted with toluene and precipitated with MeOH. The Cu NPs were isolated and identified by powder X-ray diffraction as 10 nm Cu⁰ particles. The PXRD patterns indicated that amorphous material was isolated up to 135° C. Above this temperature, crystalline Cu^{o} was formed. Based on Scheerer analyses, the crystalline samples were very regular in size above 165° C., forming particles on the order of 8-10 nm. These PXRD results agree with the TEM results, shown in FIGS. 4(a)-(h), with nanoparticles forming as low as 135° C. High quality, well-defined Cu NPs were observed between 165 to 185° C. These particles were found to be 10-15 nm, spherically shaped Cu NPs, in agreement with the PXRD analyses. Theoretical yields on this scale should produce 17.4 g of Cu NPs. Based on the simple setup and process, even larger scale processes are straightforward.

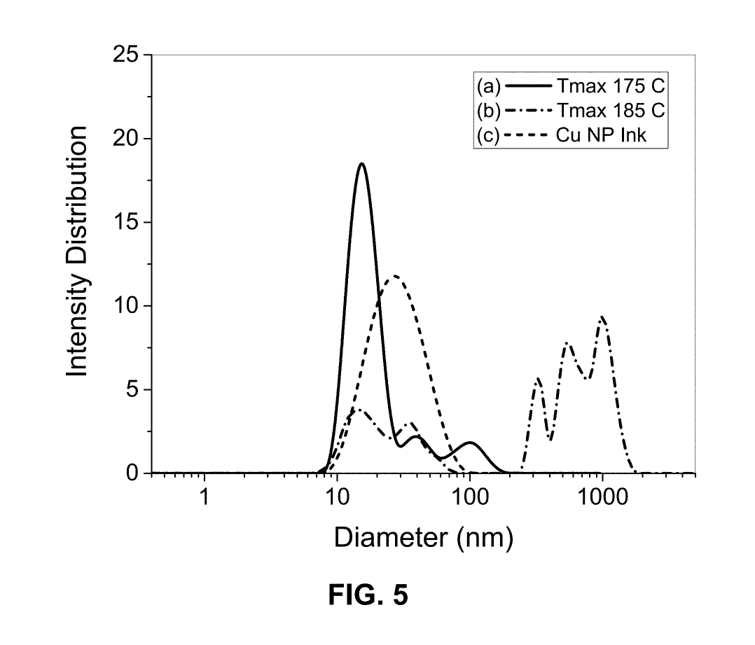

Dynamic light scattering (DLS) experiments were undertaken to further verify the size of the bulk material. FIG. 5 is a graph of DLS measurements of the Cu NPs synthesized at temperatures of 175 and 185° C. These samples were selected to study since the samples formed at lower temperature were not as uniform and since the optical properties did not match with the index of Cu NP, the interpretation of the particle size distribution for the low-temperature samples could not be performed. The data shows that nanoparticles formed at 175° C. have a distribution centered at 16.0 nm, with a standard distribution of 3.9 nm. DLS measurements show the hydrodynamic diameter of the particles, that can be slightly larger than the size measured in TEM. Growth at 185° C. leads to particle aggregation, and multiple larger peaks being modeled for the dispersion. The loss of colloidal stability at this synthesis temperature may result from more rapid ligand exchange or ligand degradation, but is unclear. The restoration of stable particle size and dispersion supports the ligand degradation effect at the elevated temperatures. Additionally, the particle size distribution of a nanoink composition comprising Cu NPs dispersed using 4 wt % Solsperse™ 9000 in a mixed solvent system of 80% xylenes and 20% white spirits is shown. These particles exhibit a single distribution centered at 30.3 nm with a standard deviation of 14 nm.

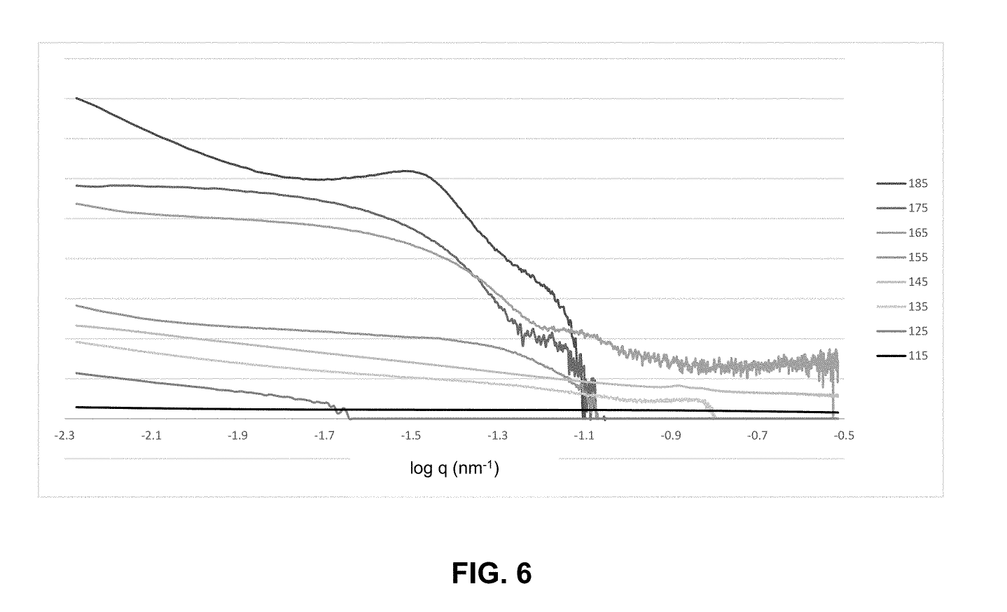

Ex-situ small angle X-ray scattering SAXS analyses were undertaken to understand the growth process of the reaction. The ex-situ temporal analysis reveals the different growth patterns of the formed NP particles and the final converted products that were formed. FIG. 6 is a graph of the SAXS data and represents particle sizes at the selected aliquot temperatures. For this set of samples, it is clear that for temperatures as low as 135° C. a nanoparticle correlation peak is present. At 155° C., the peak is more prominent and thereby suggests close-packed structures. Monodisperse oscillations are observed for the 165, 175, and 185° C. patterns. These results are consistent with the TEM images where Cu NP growth at 135° C. was observed and more uniform particles are observed at higher temperatures.

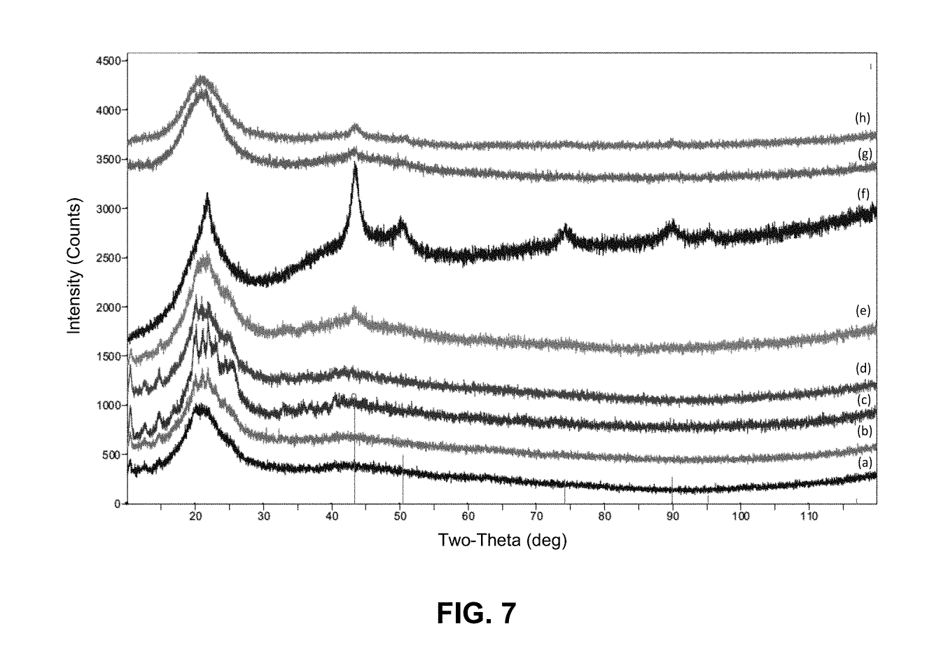

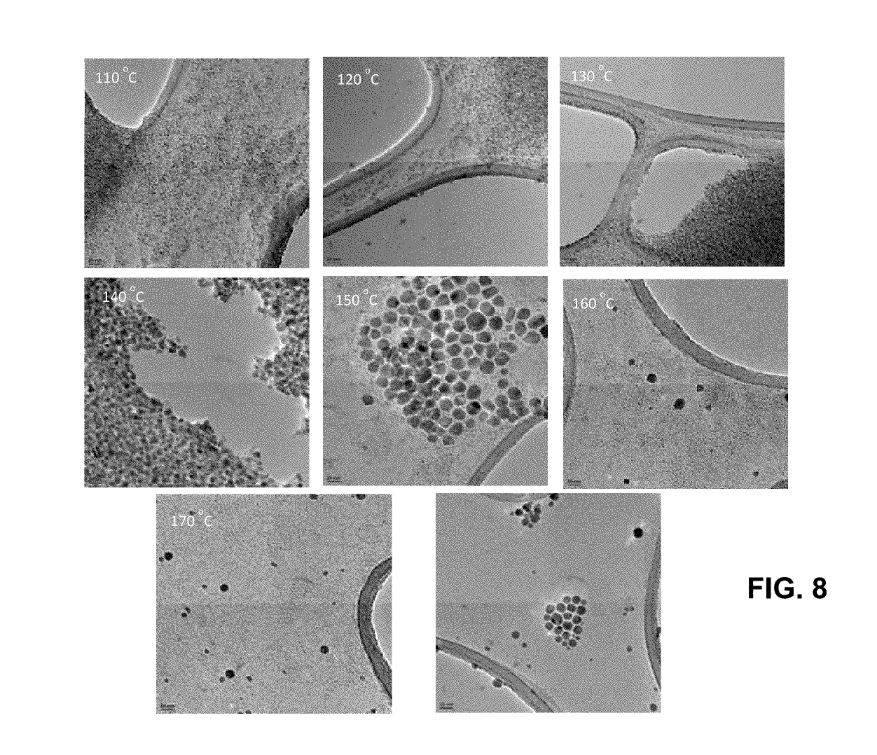

To simplify the process even further, another large-scale preparation (50 g of Cu(Mes)) was performed in a glovebox using the HDA-only route. Aliquots were collected from 110 to 180° C. at 10° C. intervals. PXRD patterns for these samples are shown in FIG. 7. Amorphous PXRD patterns were obtained from the 110-150° C. aliquots. At 160° C., the PXRD pattern clearly shows Cu NP formation (Cu⁰) with a calculated particle size of ˜6 nm. The other higher temperature samples (170° C. and 180° C.) were also consistent with the formation of 6 nm sized Cu NP. TEM images of the various aliquots collected at the different temperatures listed are shown in FIG. 8. Small particulates are observed up to 130° C. Large aggregates are noted at 140° C. These ripen into 8-10 nm sized particles at higher temperatures without growing larger. Again, this verifies the reproducibility of the low temperature process for Cu NP production at large scale.

### Nanoink Synthesis

With routes that are amenable to large-scale production of high quality Cu NP with variable surfactants as described above, the utility of each nanoink for printing Cu⁰ was evaluated. For direct write processes, these nanoinks can be deposited by forming an aerosol via either spray techniques or ultrasonic nebulization. The aerosolized droplets can be guided to the writing surface using gas flow technology, and dry on the surface. A critical aspect of the nanoinks is their ability to be aerosolized. Several fluid properties are required for aerosolization, including a low surface tension (on the order of 40 mJ/m) to enable droplet formation, a Newtonian viscosity (<100 mPas), and control of the evaporation rate to prevent drying and clogging of the gas flow deposition pathway. Once printed, the deposited droplets coalesce into lines for final drying. The line width and feature definition of these lines are dependent on the wetting properties of the nanoinks which are influenced by the solvent(s) choice. For many systems, toluene, xylene, alcohols and/or glycols are used as the solvent phase.

The development of a fluid system for the synthesized Cu NPs was based on the residual HDA stabilizing ligand on the Cu NP surface. Due to the presence of this ligand, a mixture of toluene, xylene, and white spirits was used as solvents. The ratio of these solvents was optimized to 20% white spirits in xylenes based on a series of deposition studies. Since white spirits is a mixture of aliphatic and alicyclic C7 to C12 hydrocarbons with low volatility, it is a poorer solvent medium for the amine-coated Cu NP. This assists in the prevention of line spreading during the printing process, as a gelled particle network during drying will resist capillary driven migration on the surface. A hyperdispersant can be used to improve particle dispersion stability for the ink composition. Solsperse 9000 was chosen as dispersing agent in the Cu NP ink formulation due to its low temperature thermal degradation (i.e. ˜350° C.). (Solsperse™ 9000 is an active polymeric hyperdispersant sold by the Lubrizol Corporation). Dispersion testing using commercial Cu NPs in xylene indicated that 4 wt % Solsperse 9000 hyperdispersant was the optimal level to obtain a stable particle size of ˜40 nm. Therefore, a nanoink comprised of Cu NPs, 4 wt % Solsperse 9000 (to the Cu NP mass), and a solvent mixture of 80% xylenes-20% white spirits was formulated. Mixing by rotary shaker was used to disperse the Cu NPs in the sovent mixture until a uniform dispersion was present (i.e. until aggregates/clumps on the walls are no longer present once mixing ceases). An ultrasonic bath was used to lightly agitate residual sediment until a uniform dispersion was achieved.

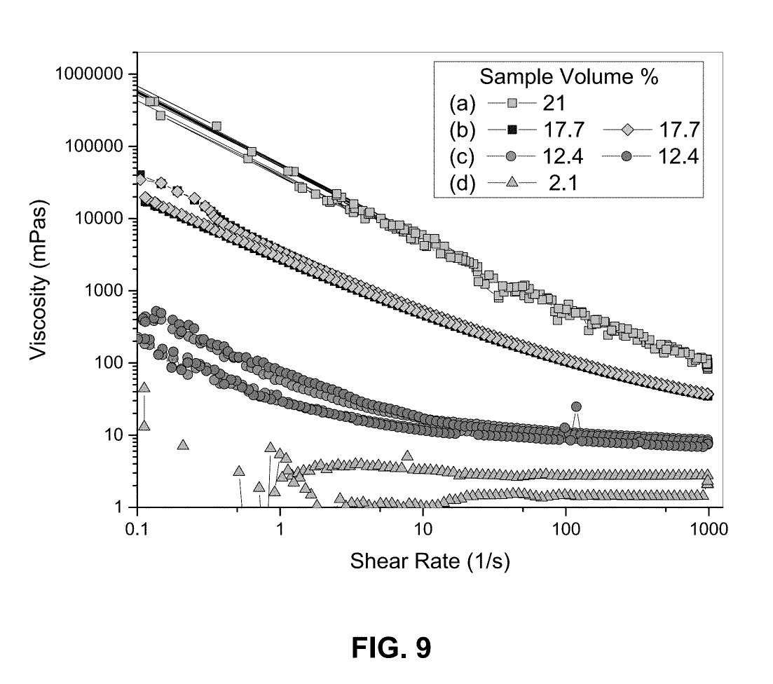

Rheological testing of the viscosity of four solid loadings of Cu NPs from HDA-only preparations (0.6 g (2.1%), 2.5 g (12.4%), 4.5 g (17.7%) and 6.5 g (21%)) was undertaken. As mentioned, the larger particles of 8N-only preparations made them less attractive for nanoink production and the mix samples should behave similar to the HDA-only samples due to their similar size. Manual mixing of mixtures was followed by mechanical shear rate sweeps at 1000 s−1 rates. The results from these viscosity profile studies are shown in FIG. 9. The plots show the characteristic behavior for fluid particulates. For the lowest content of Cu NP, the viscosity was consistent with what was observed for xylene alone (2-3 cP). As additional Cu NPs are added, the solution displays a shear thinning behavior, in which viscosity values start at 400-500 cPs and thin to 10 cPs above shear rates of 20 s⁻¹. As the shear rate is reduced from 1000 s⁻¹, there is a visible hysteresis, which is a sign that there is some flocculation in the system coupled with hydrodynamic flows that are caused by shear break up of particle structure; however, this is restored upon resting, as the second test shows similar behavior. At 17.7 vol %, the viscosity profile is much higher and pseudo-plastic behavior is observed with a breakdown of associated particles from viscosities of ˜30,000 cPs to values under 100 cPs at 1000 s⁻¹. This structure of agglomerated Cu NPs also breaks down but the transition occurs at a lower shear rate of ˜0.5 s⁻¹. This also indicates for the 17.7 vol % nanoink that the nanoparticles are not well dispersed and a structure in the system is formed. Attempts to generate a nanoinks at higher Cu NP content (>21 vol %) were unsuccessful, as there were undispersed particles present, and thus the fluid phase has a lower concentration than formulated.

Each of these nanoinks were expected to be useful for aerosol deposition and inkjet printing of low viscosity inks for sub 50 μm range components due to the properties noted above. Pads of the various Cu nanoinks were printed onto a coupon using a NanoJet printer equipped with a 335-micron nozzle onto a 5 mil Kapton substrate. The samples were printed at a speed of 1200 mm/min. The coupons were then transferred into a tube furnace flowing with 3% hydrogen/97% Argon and cured at 375° C. A 4-point test was conducted to determine the bulk resistivity and this was compared to bulk Cu⁰. The results are tabulated in Table 1.

The present invention has been described as a low-temperature method to produce coinage metal nanoparticles. It will be understood that the above description is merely illustrative of the applications of the principles of the present invention, the scope of which is to be determined by the claims viewed in light of the specification. Other variants and modifications of the invention will be apparent to those of skill in the art.

TABLE 1
Electrical properties of printed pad.

| 8N only | | HDA only | | Mix (8N/HDA) | | Original 8N/HDA^{a} | |
|---|---|---|---|---|---|---|---|
| Pad 1 | 4 point = 8.50M Ω | Pad 1 | 4 point = 0.0066 Ω | Pad 1 | 4 point = 0.0043 Ω | Pad 3 | 4 point = 0.0056 Ω |
| sample 2 | Rₛ = 3.77 × 10⁷ Ω/sq | sample 1 | Rₛ = 0.0299 Ω/sq | sample 1 | Rₛ = 0.0195 Ω/sq | sample L4 | Rₛ = 0.0254 Ω/sq |
| 1.6 μm^{b} | R_{B} = 150.24 | 3.9 μm | R_{B} = 1.167 × 10⁻⁷ | 7.1 μm | R_{B} = 1.392 × 10⁻⁷ | 4.3 μm | R_{B} = 1.091 × 10⁻⁷ |
| | R_{B/Cu} = 8.94 × 10⁹ | | R_{B/Cu} = 6.94 | | R_{B/Cu} = 8.29 | | R_{B/Cu} = 6.50 |
| Pad 2 | 4 point = 1.38M Ω | Pad 2 | 4 point = 0.0066 Ω | Pad 2 | 4 point = 0.0044 Ω | Pad 4 | 4 point = 0.0027 Ω |
| sample 2 | Rₛ = 6.11 × 10⁶ Ω/sq | sample 1 | Rₛ = 0.0299 Ω/sq | sample 1 | Rₛ = 0.0199 Ω/sq | sample L4 | Rₛ = 0.0122 Ω/sq |
| 1.6 μm | R_{B} = 25.64 | 4.1 μm | R_{B} = 1.226 × 10⁻⁷ | 7.1 μm | R_{B} = 1.416 × 10⁻⁷ | 7 μm | R_{B} = 8.565 × 10⁻⁸ |
| | R_{B/Cu} = 1.53 × 10⁹ | | R_{B/Cu} = 7.30 | | R_{B/Cu} = 8.43 | | R_{B/Cu} = 5.10 |
| Pad 3 | 4 point = 0.28M Ω | Pad 3 | 4 point = 0.0078 Ω | Pad 3 | 4 point = 0.0056 Ω | Pad 5 | 4 point = 0.0012 Ω |
| sample 2 | Rₛ = 1.24 × 10⁶ Ω/sq | sample 1 | Rₛ = 0.0354 Ω/sq | sample 1 | Rₛ = 0.0254 Ω/sq | sample L4 | Rₛ = 0.0054 Ω/sq |
| 1.5 μm | R_{B} = 6.73 | 5.3 μm | R_{B} = 1.874 × 10⁻⁷ | 6.3 μm | R_{B} = 1.599 × 10⁻⁷ | 12 μm | R_{B} = 6.526 × 10⁻⁸ |
| | R_{B/Cu} = 4.00 × 10⁸ | | R_{B/cu} = 11.15 | | R_{B/Cu} = 9.52 | | R_{B/Cu} = 3.88 |

^{a}Sample from original high temperature Cu NP prep route.
^{b}thickness of pad.
Sheet Resistance (Rₛ) = 4.532 * Ω (units Ω/sq)
Bulk Resistivity (R_{B}) = R_{B} = Rₛ * t _{(cm)} (units Ω-meter)
R_{Cu} = R_{B} of copper = 1.68 × 10⁻⁸ (units Ω-meter)
R_{B/Cu} = R_{B} of sample/RCu (times bulk)

We claim:

1. A method to produce coinage metal nanoparticles, comprising reacting a coinage metal mesityl with a solvent/reductant at a sufficiently high temperature to produce coinage metal nanoparticles.

2. The method of claim 1, wherein the coinage metal comprises copper.

3. The method of claim 1, wherein the coinage metal comprises silver or gold.

4. The method of claim 1, wherein the solvent/reductant comprises an amine.

5. The method of claim 4, wherein the amine comprises octylamine, hexadecylamine, or mixtures thereof.

6. The method of claim 1, wherein the sufficiently high temperature is greater than 130° C.

7. The method of claim 1, wherein the sufficiently high temperature is greater than 150° C.

8. The method of claim 1, wherein the sufficiently high temperature is less than 310° C.

9. The method of claim 1, further comprising mixing the coinage metal nanoparticles a hyperdispersant and a solvent to provide a nanoink.

10. The method of claim 9, wherein the hyperdispersant comprises an amine surfactant.

11. The method of claim 9, wherein the solvent comprises toluene, xylene, white spirits or mixtures thereof.

12. The method of claim 9, wherein the nanoink comprises less than 21 vol % of coinage metal nanoparticles.
